(19) United States
(12) Patent Application Publication
(10) Pub. No.: US 2025/0376334 A1
(43) Pub. Date: Dec. 11, 2025

(54) PENDULUM CONVEYOR

(71) Applicant: Magnetic Products, Inc., Highland, MI (US)

(72) Inventor: Ronald Kwasniewicz, Walled Lake, MI (US)

(21) Appl. No.: 18/874,719

(22) PCT Filed: Jun. 30, 2023
(86) PCT No.: PCT/US2023/026701

§ 371 Date: Dec. 13, 2024

Related U.S. Application Data
(60) Provisional application No. 63/357,708, filed on Jul. 1, 2022.

(51) Int. Cl. B65G 27/12; B65G 27/04; B65G 27/32

(52) U.S. Cl. CPC B65G 27/12; B65G 27/04; B65G 27/32

(57) ABSTRACT

A conveyor system including a tray suspended from above by two or more vertical supports. The tray travels in a forward direction from a tray high point toward a tray low point. The system includes a one directional continuously rotating input mechanism. During a first portion of a single rotational cycle the input mechanism moves the tray in a backward direction, toward a high point. During a second portion of a single rotational cycle the input mechanism allows unrestrained freefall of the tray in a forward direction. The system includes a bumper positioned to provide a sudden stop to the tray as the tray travels in a forward direction. The sudden stop bounces the tray in a backward direction and allows conveyed material positioned on the tray to continue in the forward direction due to forward momentum of the conveyed material.

### CROSS-REFERENCE TO RELATED APPLICATIONS

This application claims priority to U.S. Provisional Patent Application No. 63/357,708 filed on Jul. 1, 2022, the contents of which are hereby incorporated in their entirety.

### TECHNICAL FIELD

This disclosure relates generally to a pendulum conveyor, and in particular, to an improved pendulum conveyor for moving a variety of materials using kinetic energy.

### BACKGROUND

Conveyor systems are mechanical equipment used for moving products and materials from one location to another, typically in industrial environments. They are known to be used in businesses for handling items such as heavy equipment, mass-produced products, raw materials, and the like. A variety of industries use conveyor systems, resulting in an array of shapes, sizes, and operating systems depending on the requirements of a particular business.

One known conveyor system is an oscillating conveyor, which may include reciprocating or vibrating conveyors, as examples. Vibratory conveyors are of a type which bounce a product along the conveyor system path on a conveying member and move material on the conveying member that, in one example, may be in the shape of a trough. Such a system generates a vibratory force in the direction and angle of the desired path of the material on the conveying member. The material is physically lifted from the conveying member and pushed or moved forward due to the vibratory force.

However, traditional conveyor systems can be difficult to control and may exceed vibration speeds that can create harmful friction to the conveyor system while producing adverse stress on its components, which can limit system life. Moreover, reciprocating and vibrating conveyors typically need occasional maintenance due at least in part to the nature of the stress on the conveyor system parts and the friction created by the drive mechanism of the operating system. The replacement or maintenance of a worn belt or other mechanisms in the system may be costly and time consuming, shutting down the system for extended periods of time for maintenance and repairs.

Some known systems use pneumatically controlled systems or actuators that include a transport tray that is supported by a housing. A drive system acts to drive the transport tray in a rectilinear fashion to advance materials that are supported by the transport tray and in a direction extending along a length of the tray. Another known system operates using rotatable cam surfaces and cam followers that provide reciprocating movement in one direction and then in the other direction using a counterweight. The cam causes operation in one direction and then the counterweight causes motion in the opposite direction. These are but a few examples of known systems.

Generally, these and other such systems operate on a principle that is based on the distinction between static and dynamic friction. Because static friction coefficients are typically higher than dynamic friction coefficients, while in motion an object tends to remain in place until its static friction is overcome, and subsequent sliding occurs due to the lower dynamic friction during motion of the object with respect to the tray. These systems may rely on complex mechanical devices that impart sudden forward and then reverse drives that can cause undue wear and in the system, leading to wear, breakage, and costly and time-consuming repairs. Costs occur not only because of the amount of time taken to repair the machine, but also due to the downtime when product is not being moved within a facility.

Therefore, a need exists for improved material conveying systems.

### BRIEF DESCRIPTION

The disclosure is directed toward a system and method for conveying materials on a pendulum conveyor.

According to one aspect, a conveyor system includes a tray supported or suspended from above by two or more vertical supports, such that the tray travels in a forward direction from a tray high point to a tray low point. The system includes a one directional continuously rotating input mechanism that during a first portion of a single rotational cycle moves the tray in a backward direction, opposite the forward direction, to the tray high point, and during a second rotational cycle allows unrestrained freefall of the tray in the forward direction. The one directional continuously rotating input mechanism is a single speed motor which has a constant rotation per minute. The system includes a bumper positioned to provide a sudden stop to the tray as the tray travels in the forward direction, such that the tray bounces and travels in the backward direction, and such that a conveyed material positioned on the tray continues in the forward direction due to a forward momentum of the conveyed material.

According to another aspect, a method of conveying materials includes moving a tray in a backward direction during a first portion of a rotational cycle, such that the tray is configured to move by a one-directional continuously rotating input mechanism, releasing the tray in unrestrained freefall in a forward direction during a second portion of a rotational cycle, providing a sudden stop to the tray at a bumper as the tray travels in the forward direction, and bouncing the tray in a backward direction, such that conveyed material on the tray continues in a forward direction due to a forward momentum of the conveyed material.

Various other features and advantages will be made apparent from the following detailed description and the drawings. For example, it will be apparent by the disclosure that the system and method disclosed could be used in various other contexts including with different input mechanisms, with different size conveyor systems, and with moving a variety of conveyed materials.

### BRIEF DESCRIPTION OF THE DRAWINGS

FIG. 1 is a schematic drawing generally illustrating a first embodiment of a pendulum conveyor system.

FIG. 2 is a flowchart generally illustrating a method of conveying materials according to the present disclosure.

FIG. 3A is a schematic drawing generally illustrating a step of an embodiment of a conveyor system according to the present disclosure.

FIG. 3B is a schematic drawing generally illustrating a step of an embodiment of a conveyor system according to the present disclosure.

FIG. 3C is a schematic drawing generally illustrating a step of an embodiment of a conveyor system according to the present disclosure.

FIG. 3D is a schematic drawing generally illustrating a step of an embodiment of a conveyor system according to the present disclosure.

FIG. 4 is a rear view generally illustrating a one directional continuously rotating input mechanism coupled to a tray according to the present disclosure.

FIG. 5 is a perspective view generally illustrating a tray suspended by vertical supports according to the present disclosure.

FIG. 6 is a side view generally illustrating a one directional continuously rotating input mechanism coupled to a tray according to the present disclosure.

FIGS. 7A and 7B illustrate one example of a sprag bearing.

FIG. 8 is a perspective view generally illustrating two trays coupled according to the present disclosure.

FIG. 9 is a schematic drawing generally illustrating the operation of a cam and follower according to the present disclosure.

FIG. 10 is a schematic drawing generally illustrating an embodiment of a self-compensating connecting rod according to the present disclosure.

FIG. 11A is a schematic drawing generally illustrating an embodiment of a pendulum conveyor system.

FIG. 11B is a schematic drawing generally illustrating an embodiment of a pendulum conveyor system.

FIG. 12A is a schematic drawing generally illustrating an embodiment of a bumper of a pendulum conveyor system.

FIG. 12B is a schematic drawing generally illustrating an embodiment of a flexible strap of a pendulum conveyor system.

FIG. 12C is a schematic drawing generally illustrating an embodiment of the frame of a pendulum conveyor system.

### DETAILED DESCRIPTION

Referring now to the discussion that follows and the drawings, illustrative approaches to the disclosed systems and methods are described in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive, otherwise limit, or restrict the claims to the precise forms and configurations shown in the drawings and disclosed in the following detailed description.

This disclosure relates generally to a pendulum conveyor system for moving conveyed materials along a tray. An exemplary conveyor system includes a tray supported or suspended from above by two or more vertical supports, such that the tray travels in a forward direction from a tray high point toward a tray low point. A one directional continuously rotating input mechanism operates such that during a first portion of a single rotational cycle it moves the tray in a backward direction, opposite the first direction, to the tray high point. During a second portion of the single rotation cycle, the system allows unrestrained freefall of the tray in the forward direction. The one directional continuously rotating input mechanism includes a single speed motor such that it rotates with a constant rotations per minute. A bumper is positioned to provide a sudden stop to the tray as the tray travels in the forward direction, such that the tray bounces and travels in the backward direction and a conveyed material positioned on the tray continues in the forward direction due to a forward momentum of the conveyed material.

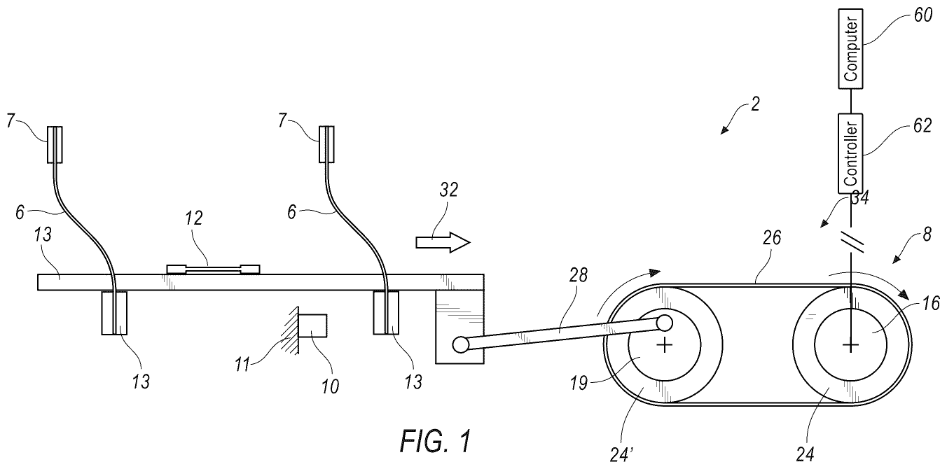

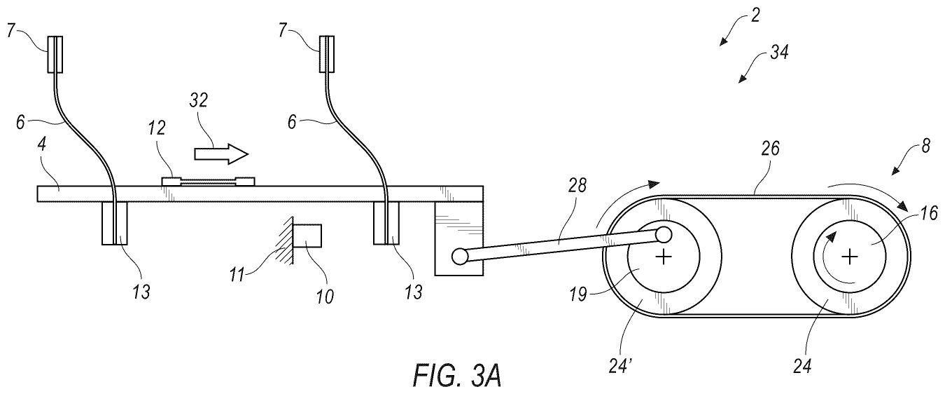

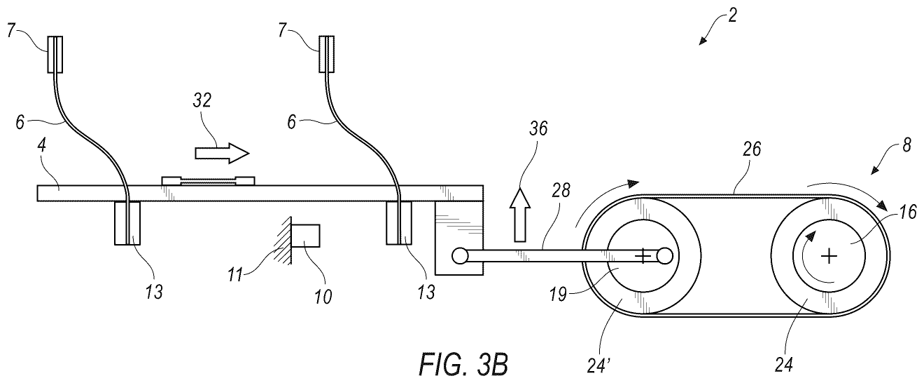

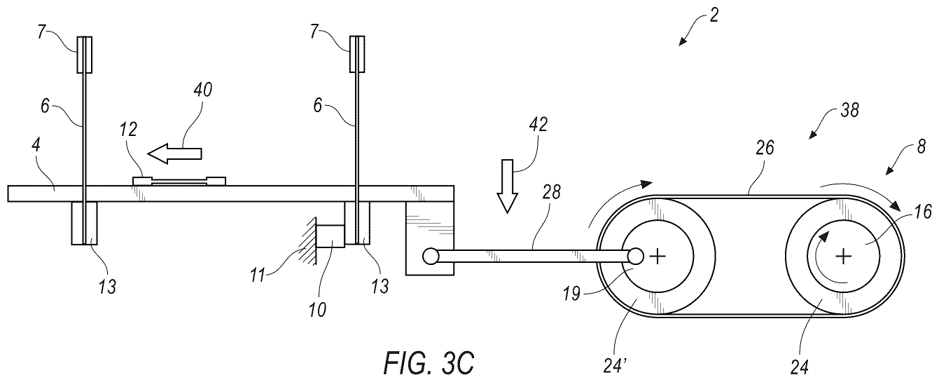

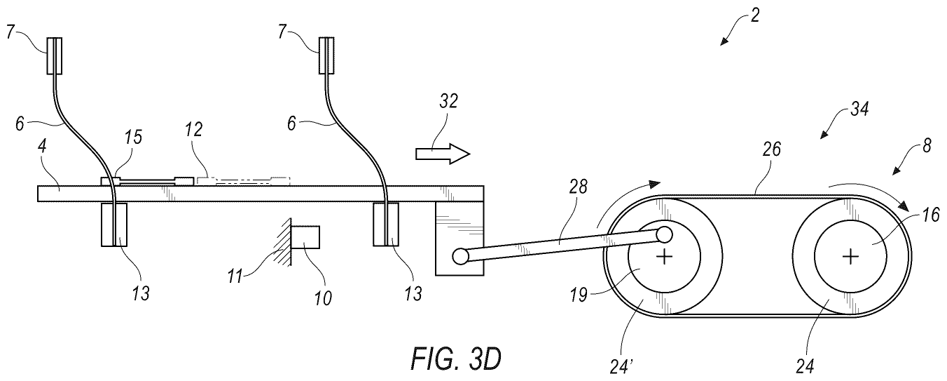

Referring to the figures and as generally illustrated in FIG. 1-8, a conveyor system 2 includes a tray 4 suspended from above by two or more vertical supports 6 that are themselves suspended from stationary upper locations 7, which may be a support bracket or attachments to a ceiling, wall, or floor, as examples. Vertical supports 6 are suspended from above such that tray 4 travels in a backward direction 32 to a tray high point 36 and then in a forward direction 40 and downward 42 to a tray low point of tray 4. Conveyor system 2 includes a one directional continuously rotating input mechanism 8 (or simply input mechanism 8) that, during one portion 34 (FIG. 3A) of a single rotational cycle, moves tray 4 in backward direction 32, opposite forward direction 40, and upward 36 to a high point of tray 4. During another portion 38 (FIG. 3C) of a single rotational cycle, one directional continuously rotating input mechanism 8 allows unrestrained freefall of tray 4 downward 42 and in forward direction 40. Forward direction 40 and backward direction 32 motions of tray 4 occur due to a flexible nature of vertical supports 6, which in one example are flexible straps made of heavy duty cloth or other material that allows a swinging motion of tray 4, such as a flexible metal bar that bends forward and aft, or a rope that is steel enforced, as examples. Thus, in general, “unrestrained freefall” refers to tray 4 swinging forward by gravity as if on a rope or other device that does not hinder its motion. Unrestrained freefall may also refer to moving forward if tray 4 is supported by, for instance, a flexible metal bar or other material that when pulled in one direction provides some resistance to motion due to its bending in the elastic region, such that release then moves the tray forward not only by gravity but also by restoring eventually to its unconstrained unbent position.

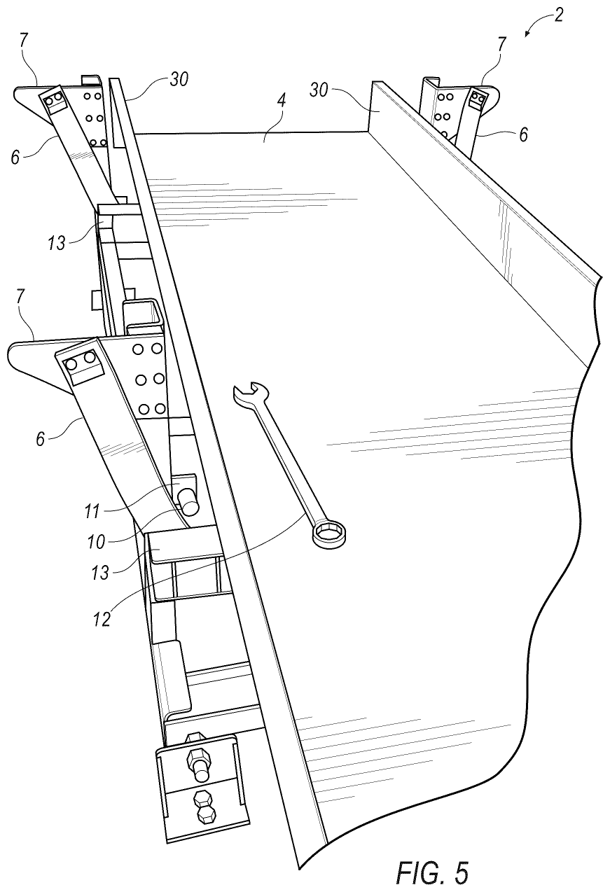

Conveyor system 2 includes a bumper 10 positioned to provide a sudden stop to tray 4 as tray 4 travels in forward direction 40, such that tray 4 bounces and travels in backward direction 32, and such that a conveyed material 12 positioned on tray 4 continues in forward direction 40 due to forward momentum of conveyed material 12. Bumper 10 in one example is connected to a support structure or other hard mount within conveyor system 2 (as seen in FIG. 5), or bumper 10 may be separate from conveyor system 2 altogether and hard mounted in an appropriate location and attached to the floor, as examples.

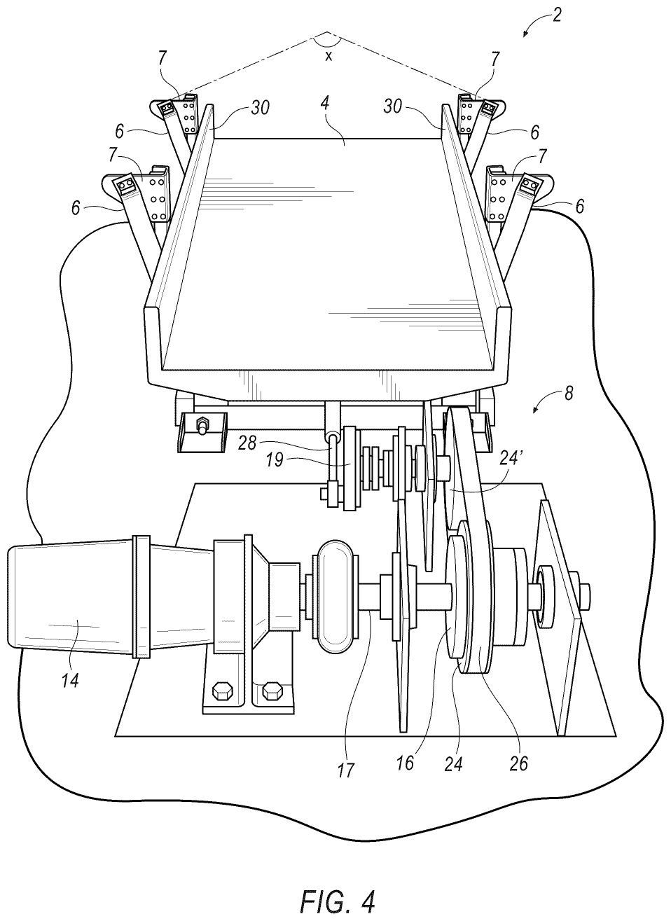

In one example, vertical supports 6 are positioned such that tray 4 is prevented from swaying sideways due to the spread out or “V” shape of vertical supports 6 and as seen in FIG. 4. Such prevention is because an angle X, shown in FIG. 4 and extending generally along the length of each vertical support 6, which form the “V”, which thereby prevents tray 4 from side-to-side swinging motion. Tray 4 thereby swings forward and backward from vertical supports 6, with the V shaped arrangement of vertical supports 6 preventing side-to-side motion, and if its motion were not constrained by bumper 10, would continue to swing back and forth until coming eventually to a stop. In one example, angle X is approximately thirty degrees, but is not limited to that angle and vertical supports 6 may be positioned vertically without a “V” shape in other examples.

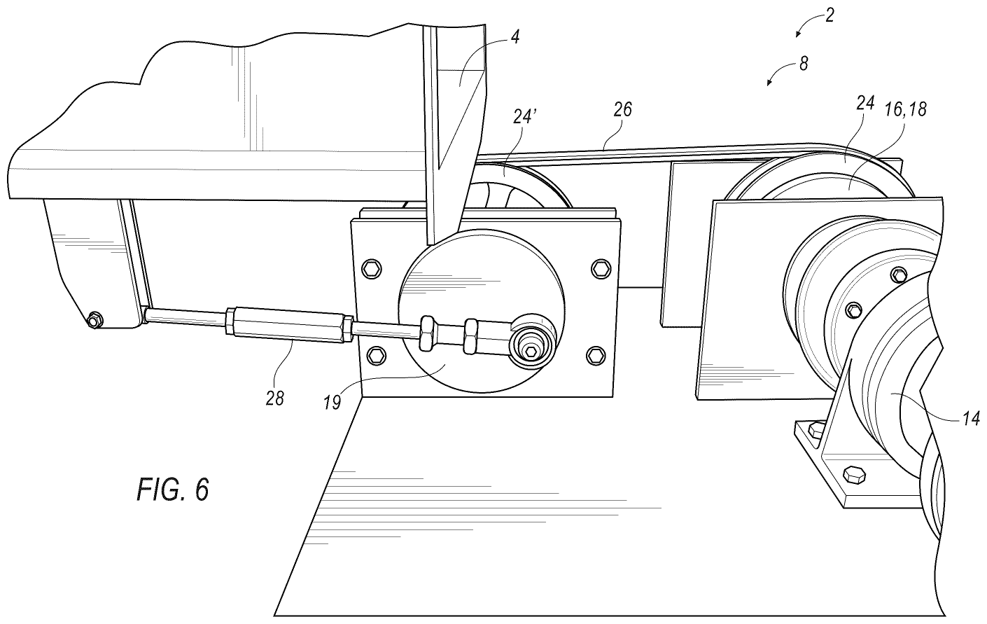

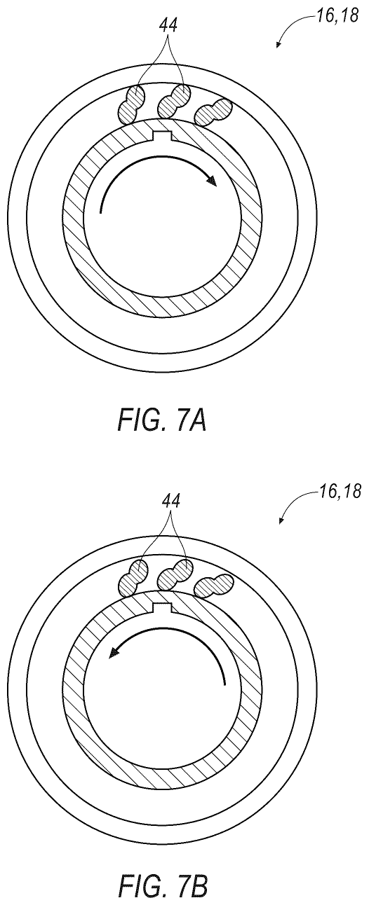

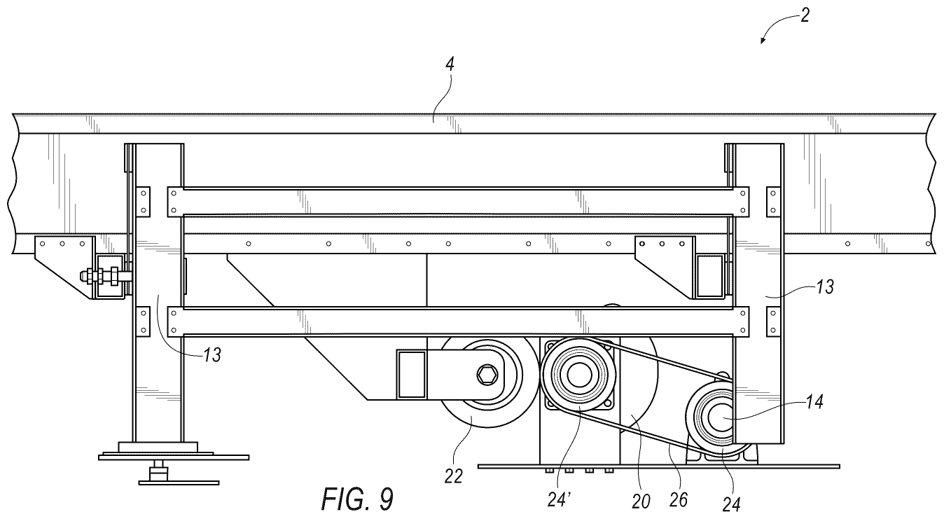

One directional continuously rotating input mechanism 8 includes a continuously rotating single speed motor 14 (FIG. 6) and a one directional bearing 16. Single speed motor 14 operates at a constant speed such that the continuously rotating input mechanism 8 rotates with a constant rotation per minute. One directional bearing 16 is, in one example, a sprag bearing 18 (shown in FIGS. 7A and 7B) but may also be other one-directional mechanisms such as a cam 20 (FIG. 9) and follower 22 mechanism. Single speed motor 14 of one directional continuously rotating input mechanism 8 is coupled to tray 4. Single speed motor 14 is connected to one directional bearing 16 via a shaft 17. One directional bearing 16 is positioned inside a first pulley wheel 24 such that pulley wheel 24 rotates with one directional bearing 16. First pulley wheel 24 is connected to second pulley wheel 24′ via belt 26 such that first pulley wheel 24 and second pulley wheel 24′ rotate with each other. A drive arm or connecting rod 28 is connected to second pulley wheel 24′ such that as second pulley wheel 24′ rotates, drive arm 28 and tray 4 connected to drive arm 28 move in backward direction 32 and forward direction 40. Bumper 10 is positioned, in the illustrated example, in one example, past tray low point 42 such that tray 4 is configured to travel to and then through, tray low point 42. In another example bumper 10 is positioned (not shown) prior to passing tray low point 42.

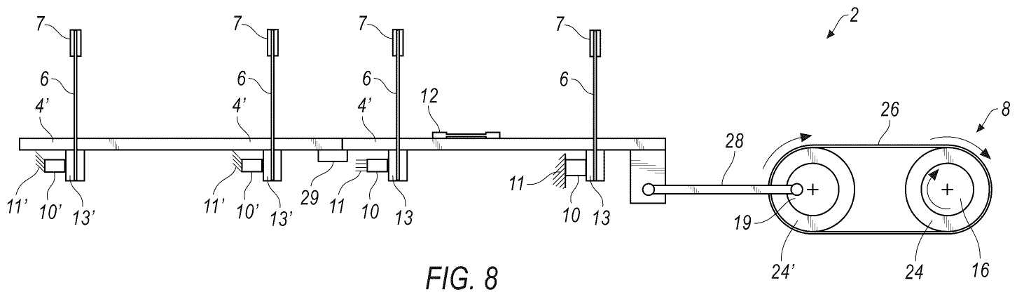

Tray 4 in one example is a trough including side walls 30. Side walls 30 may be included to avoid any inadvertent sideways motion of conveyed material 12 from being dropped off the sides of tray 4, or to prevent conveyed materials from dropping off the sides when dropped or otherwise placed onto tray 4. Conveyor system 2 may include at least a second tray 4′, shown in FIG. 8, supported by two or more vertical supports 6, with tray 4 and second tray 4′ coupled to one another. Second tray 4′ may be coupled to first tray 4 by a hard coupling, or may be loosely coupled to first tray 4 via a hook or bracket 29, such that second tray 4′ may move with first tray 4 via hook 29, second tray 4′ travels to a tray low point 42 less far than first tray 4, and second tray 4′ hits bumper 10 before first tray 4, yet the coupling via hook or bracket 29 thereby allows a slight backward motion of second tray 4′ due to their axial coupling, but not so much as to allow a significant gap between trays 4 and 4′, so as to avoid any conveyed material 12 from falling in between. Thus, trays 4 and 4′ may push each other until tray 4 encounters bumper 10, while hook 29 allows further forward motion until bumper 10′ is encountered. As such, in operation first tray 4 hits its respective bumper 10 on the down swing, and then second tray 4′ subsequently hits its bumper 10′, avoiding the operation of the two from interfering with each other.

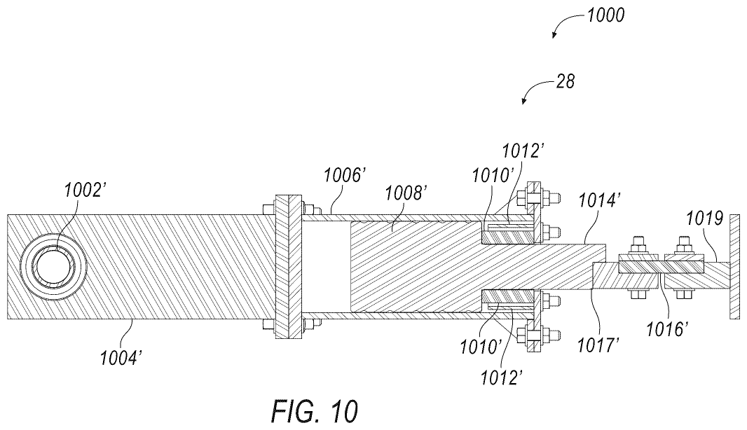

A method of conveying materials 12 with conveyor system 2 includes moving tray 4 in backward direction 32 during first portion 34 of rotational cycle, tray 4 being configured to be moved by one directional continuously rotating input mechanism 8. System 2 includes releasing tray 4 in unrestrained freefall in forward direction 40 during second portion 38 of rotational cycle. System 2 includes providing a sudden stop to tray 4 at bumper 10 as tray 4 travels in forward direction 40. System 2 includes bouncing tray 4 in a backward direction 32 such that conveyed material 12 on tray 4 continues in forward direction 40 due to forward momentum of conveyed material 12. System 2 includes hanging tray 4 from two or more vertical supports 6. System 2 includes swinging tray 4 from two or more vertical supports 6. System 2 includes drive arm 28 (FIG. 10) coupling from tray 4 to one directional continuously rotating input mechanism 8.

Referring now to FIG. 1, conveyor system 2 includes tray 4 for moving conveyed materials 12. Conveyed materials 12 travel along the top surface of tray 4. Materials 12 are of varying shapes, sizes, and weights. Tray 4 in one example is a horizonal surface but could be a trough which includes side walls to keep materials 12 on tray 4. Tray 4 is supported by two or more vertical supports 6.

For example, a small tray could include two vertical supports on either side of a first end of a tray. A larger tray could include several pairs of vertical supports positioned along the length of the tray. It typically may be desirable to include an even number of two, four, six, eight, or more vertical supports 6 for optimal load balancing and operation, however an odd number of vertical supports 6 may be used in some examples. It is understood that the minimum necessary for operation is two and perhaps in a smaller or more compact design. With a vertical support on either side of tray 4 the fundamental back and forth swinging motion of tray 4 may occur.

Tray 4 is supported from vertical supports 6 and such that tray 4 hangs and swings from vertical supports 6. Vertical supports 6 in one example are flexible straps supported by stationary upper locations 7 (such as a frame on the floor or an overhead ceiling or support structure), and attached to tray 4 via support bars 13, to allow tray 4 to swing and travel from tray high point 36 when moved back to tray low point 42 near where bumper 10 is encountered. Straps may be flexible cloth or rope, or metal strips that bend while swinging. Additionally, straps could be of other materials such as leather or a polymer.

Attached to system 2 is bumper 10 which, in one example, is rubber. Additionally, bumper 10 may be another material including but not limited to other polymer compositions such as polypropylene or urethane. Such materials operate in their elastic region, temporarily deforming due to the impact. Bumper 10 is positioned such that tray 4 travels to and/or through tray low point 42 before hitting bumper 10. Bumper 10 is mounted to a bumper support 11 which in one example may be separate from the frame (as illustrated in FIG. 1).

In other words, referring back to FIG. 8 bumper 10 may contact tray 4 at one of support bars 13 as shown, or at a location that is hard mounted to tray 4 but separate from support bars 13. In the illustrated example, one of support bars 13 is used both to support one of vertical supports 6, and to dually serve as a convenient spot for bumper 10 to contact. Bumper 10 prevents additional travel in the forward direction 40 of tray 4, causing tray 4 to bounce and travel in the backward direction 32. Conveyed material 12 on tray 4 continues moving in the forward direction 40 due to the forward momentum of conveyed material 12.

Attached to tray 4 is drive arm 28 coupled to one directional continuously rotating input mechanism 8. Drive arm 28 connects tray 4 such that rotation from input mechanism 8 moves tray 4 in backward direction 32 during first portion 34, shown in FIG. 3B, of a single rotational cycle. Weight of tray 4 increases rotational speed of one direction bearing 16, allowing unrestrained freefall in forward direction 40 during second portion 38, shown in FIG. 3C, of a single rotational cycle.

One directional continuously rotating input mechanism 8 includes continuously rotating single speed motor 14 and one directional bearing 16. In the illustrated example, one directional bearing 16 is a sprag bearing 18 but is not limited to sprag bearing 18 and could be, for instance, a cam 20 and follower 22 mechanism such as illustrated in FIG. 9. One directional bearing 16 in the illustrated example is separate from continuously rotating single speed motor 14. One directional bearing 16 is connected to continuously rotating single speed motor 14 via a shaft 17. One directional bearing 16 is integrated in a first pulley wheel 24. First pulley wheel 24 is coupled to second pulley wheel 24′ via belt 26.

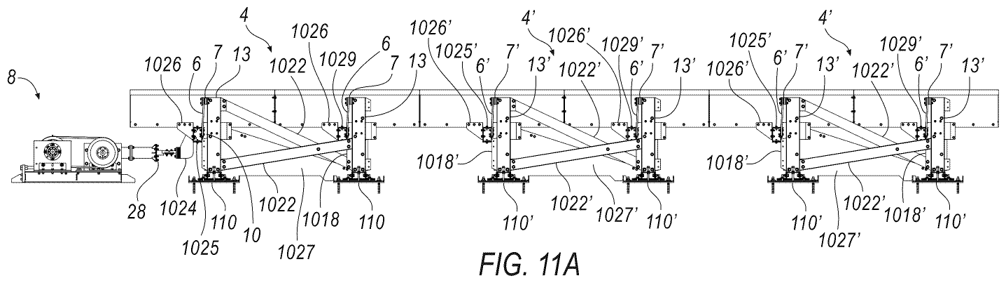

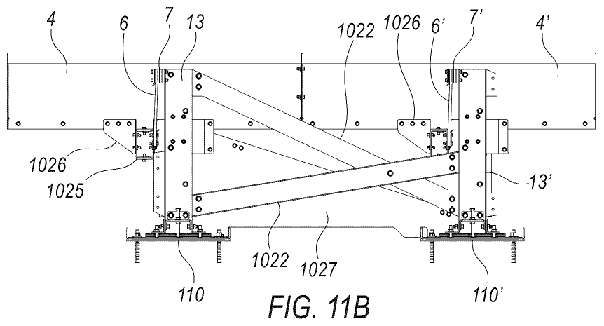

In examples, as illustrated in FIG. 1, one directional continuously rotating input mechanism 8 may be electrically connected to a controller 62 which may be further connected to a computer 60. For example, input mechanism 8 may be directly connected to controller 62 via a wired connector or via, for example, Bluetooth or other wireless connection. Controller 62 and computer 60 may be used to, for example, manage, control, or maintain operation of conveyor system 2, for example providing power to the motor 14, recording data from sensors 1018 (as described below regarding FIG. 11A), maintaining schedules for maintenance and use. It is contemplated, according to the disclosure, that controller 62 and computer 60 may not be included and input mechanism 8 may be controlled manually.

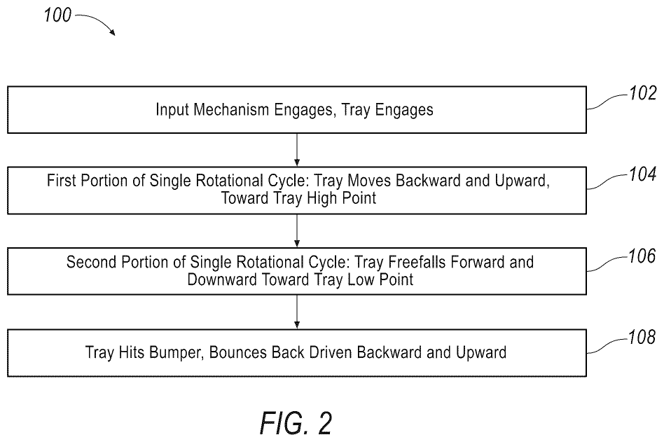

FIG. 2 is a flowchart of the operational steps 100 as illustrated in FIGS. 3A-3D. FIGS. 3A-3D generally illustrate operational steps 100, and the relative distance between components may not be to scale. Illustrations of positions such as tray high point 36 and tray low point 40 may be simplified in their illustrations for ease of understanding and may not be to scale. In step 102 corresponding with FIG. 3A, one directional continuously rotating input mechanism 8 engages. Single speed motor 14 is engaged and begins to rotate at a constant rotation per minute.

The illustrations of FIGS. 3A-3D represent one complete cycle and are illustrated with an arbitrary start of the cycle and end of the cycle, for illustration and discussions purposes only. For example, FIGS. 3A and 3D both show conveyor system 2 at the same arrangement but in FIG. 3D conveyed material 12 is moved to its new position 15. Further, and again noting that the drawings are not to scale, for discussion purposes it is understood that in FIGS. 1, 3A, 3B, 3C, and 3D, stationary upper locations 7, bumper 10, bumper support 11, and one directional continuously rotating input mechanism 8 are all located in the same relative positions from illustration to illustration, and during operation of one directional continuously rotating input mechanism 8 tray 4 moves relative to bumper 10, and tray 4 is caused to go through the motions described such that one of support bars 13 is caused to bump against bumper 10 causing a sudden change of direction of tray 4 as discussed herein, causing conveyed material 12 to move to its new position 15.

In step 104 and corresponding with FIG. 3B, tray 4 begins to travel in backward direction 32 to tray high point 36 reached during first portion 34 of single rotational cycle. Single speed motor 14 transfers rotational movement to one directional bearing 16 via shaft 17. One directional bearing 16 rotates first pulley wheel 24 and thus second pulley wheel 24′ via belt 26. Drive arm 28 connects second pulley wheel 24′ to tray 4 such that tray 4 moves backward and upward during first portion 34 of rotational cycle. During first portion 34, motor 14 and one directional bearing 16 are directly coupled and rotate at approximately the same speed.

In step 106 and corresponding with FIG. 3C (shown at the end of the freefall of tray 4), second portion 38 of single rotational cycle occurs. When high point 36 for tray 4 is reached at the end of step 104, freefall begins with slippage occurring in sprag bearing 18. Weight of tray 4 moves sprag bearing 18, increasing the rotational speed of sprag bearing such that it exceeds the rotational speed of motor 14 and allows tray 4 to freefall forward and downward toward tray low point 42.

At the end of freefall, tray 4 contacts bumper 10 causing sudden deceleration of tray 4. While tray 4 no longer has forward momentum, conveyed material 12 still has forward momentum, causing material 12 to overcome static friction and continue traveling in forward direction 40. Tray 4 bounces in backward direction 32 from bumper 10 before drive arm 28 and input mechanism 8 re-engage, driving tray 4 in a backward direction 32 and restarting the rotational cycle.

Step 102 and FIG. 3A thereby shows one directional continuously rotating input mechanism 8 as it engages such that motor 14 and one directional bearing 16 rotates. Drive arm 28 is coupled from tray 4 to input mechanism 8 such that tray 4 travels with movement produced from input mechanism 8.

Step 104 and FIG. 3B shows input mechanism 8 in first potion 34 of rotational cycle. During first portion 34 of rotational cycle, input mechanism 8 moves tray 4 in backward direction 32 via drive arm 28, pulley wheels 24, 24′, belt 26, one directional bearing 16, shaft 17, and motor 14. Conveyed material 12 is positioned on tray 4 and remains in place on tray 4 due to its inability to overcome static friction. Vertical supports 6 swing with tray 4. Input mechanism 8 via motor 14 and one directional bearing 16 have moved tray 4 backward and upward to tray high point 36. From this position, input mechanism 8 begins second portion 38 of rotational cycle.

In step 106 and FIG. 3C, input mechanism is in second portion 38 of rotational cycle. Weight of tray 4 moves one directional bearing 16 at an increased rotational speed, allowing unrestrained freefall of tray 4. Tray 4 travels in forward direction 40 toward tray low point 42. Tray 4 comes in contact with bumper 10, causing a sudden deceleration of forward travel of tray 4, bouncing tray 4 in backward direction 32. At time of impact, forward momentum of conveyed material 12 continues, causing material 12 to continue moving in forward direction 40.

In step 108 and FIG. 3D, conveyed material 12 advances forward to a new position 15 on tray 4 due to overcoming its static friction due to the forward momentum of conveyed material 12. FIG. 3D illustrates anew position 15 for conveyed material 12 as single rotational cycle of input mechanism 8 begins again.

FIG. 4 illustrates a rear view of conveyor system 2 and one directional continuously rotating input mechanism 8 coupled to tray 4. Input mechanism 8 includes single speed motor 14, shaft 17, one directional bearing 16, pulley wheels 24, 24′ and belt 26. One directional bearing 16 is coupled to tray 4 via drive arm 28, pulley wheels 24′ and belt 26. Motor 14 and bearing 16 are connected via shaft 17 such that rotational movement from motor 14 may be provided to bearing 16. One directional bearing 16 is illustrated having sprag bearing 18, but could be another mechanism such as cam 20 and follower 22 (illustrated in FIG. 9). Sprag bearing 18 is integrated in first pulley wheel 24. First pulley wheel 24 is connected to a second pulley wheel 24′ via belt 26. Second pulley wheel 24′ rotates with a crank journal 19, which also may be referred to a crank pivot or a crank arm face, attached to drive arm 28 end. Drive arm 28 connects tray 4 to a crank journal 19 such that movement may be transferred from tray 4 to one directional bearing 16 and vice versa.

Motor 14 rotates at a single speed during operation. During first portion 34 of single rotational cycle, motor 14 rotates at approximately the same speed as sprag bearing 18. Sprag bearing 18 drives tray 4 backward and upward via the pulley wheels 24, 24′, belt 26, crank journal 19, and drive arm 28. During second portion 38 of single rotational cycle, weight of tray 4 moves drive arm 28. Sprag bearing 18 is able to rotate ahead of motor 14 under the weight of tray 4, allowing tray 4 to fall forward in a freefall. Increased rotational speed of sprag bearing 18 rotation is transferred to tray 4 by pulley wheels 24, 24′, belt 26, and drive arm 28 such that tray 4 freefalls. At end of second portion 38 of single rotational cycle, tray 4 contacts bumper 10, decelerating tray 4 and bouncing tray 4 in backward direction 32. Sprag bearing 18 slows to speed of motor 14 and is driven by motor 14 in first portion 34 of the next rotational cycle.

Referring specifically to FIGS. 1 and 3A-3D, it is again noted that the drawings are not to scale and aspects of the drawings are included for illustrative purposes by, for instance showing what may be over-exaggerated amounts of motion of tray 4, in order to clearly illustrate in FIG. 3A that tray 4 is pulled back from bumper 10, FIG. 3B shows bumper 10 pulled back yet further, and FIG. 3C shows engagement of support bars 13 with bumper 10, and FIG. 3D shows both the movement of material 12 to its location 15 due to its forward momentum, while in the same Figure tray 4 is again pulled back from bumper 10 as the next cycle progresses. Stationary elements 7, bumper 10, and input mechanism 8 are in their same relative locations from Figure to Figure, while the cyclical operation results in the operation disclosed herein that results in the forward motion of material 12.

FIG. 5 illustrates a perspective view of tray 4 as suspended by vertical supports 6 from upper location 7. Tray 4 is a trough with side walls 30 to prevent conveyed material 12 from falling off tray 4 due to potential horizontal movement. In the illustrated example, tray 4 is suspended from above by four vertical supports 6, having two on each side of tray 4 (only three vertical supports are shown in figure).

Illustrated in FIG. 6 is a side view of one directional continuously rotating input mechanism 8 coupled to tray 4. Input mechanism 8 includes one directional bearing 16. One directional bearing 16 is sprag bearing 18, but may be another mechanism such as a cam 20 and follower 22 mechanism as illustrated in FIG. 9. One directional bearing 16 is configured to include operation of first portion 34 and second portion 38 of a single rotational cycle that exhibit a driven movement in a backward direction 32 and a freefall movement in a forward direction 40. One directional bearing 16 is coupled to motor 14 via shaft 17. Sprag bearing 18 is integrated into pulley wheel 24 which is coupled to second pulley wheel 24′ via belt 26. Second pulley wheel 24′ is coupled to drive arm 28 via a crank journal 19 such that sprag bearing 18 and drive arm 28 may move together via the pulley wheels 24, 24′ and belt 26. One directional bearing 16 is indirectly coupled to tray 4 via drive arm 28 such that tray 4 travels in a freefall forward direction 40 and a driven backward direction 32 with one directional bearing 16.

Referring to FIGS. 4 and 5, vertical supports 6 are suspended from stationary upper location 7, illustrated as a support bracket. Upper location 7 may also be a ceiling as another example. Vertical supports 6 are suspended from stationary upper location 7 such that tray 4 travels in forward direction 40 from tray high point 36 toward tray low point 42 during operation of system. Vertical supports 6 are positioned such that tray 4 is prevented from swaying sideways due to the spread out or “V” shape of vertical supports 6 created by angle X, but in one example vertical supports 6 are straight and hanging. Vertical supports 6 in one example are flexible straps supported by stationary upper locations 7, and attached to tray 4 via support bars 13, to allow tray 4 to swing and travel from tray high point 36 to tray low point 42. Straps may be flexible cloth or rope, or metal strips that bend while swinging. Additionally, straps could be of other materials such as leather or a polymer.

FIGS. 7A and 7B illustrate one example of one directional bearing 16 as a sprag bearing 18. Sprag bearing 18 is one directional clutch with non-revolving asymmetric figure-eight shaped sprags 44, or other elements allowing single directional rotation. In a first rotating direction, sprags 44 slip, allowing one directional bearing 16 to rotate in a free-wheel motion. In a second, opposite direction when torque is applied, sprags 44 tilt slightly, wedging themselves between the walls of the bearing and binding due to friction. The backstopping action due to wedging keeps the one directional bearing 16 a one-directional mechanism.

Tray 4 may be of varying lengths to convey materials 12 according to needs. Additionally, at least two trays 4, 4′ may be coupled together to produce a longer system 2. As illustrated in FIG. 8, first tray 4 is supported from above by two or more vertical supports 6 and upper locations 7. Vertical supports 6 are connected to tray 4 at support bars 13. Coupled to end of first tray 4 is a second tray 4′ supported by two or more vertical supports 6, having optionally its own bumper 10′, and support bar or bars 13′. First tray 4 and second tray 4′ each are positioned such that trays will contact a first bumper 10 and a second bumper 10′. Second tray 4′ is hard coupled to first tray 4 such that as first tray 4 moves in backward direction 32 during first portion 34 of rotational cycle by one directional continuously rotating input mechanism 8, second tray 4′ travels with first tray 4. Second tray 4′ may also be loosely coupled to first tray 4 such that second tray 4′ is configured to hit second bumper 10′ before first tray 4 hits first bumper 10 and travel in forward direction 40 for a shorter distance than first tray 4. Positioning in a loosely coupled system 2 is done such that first tray 4 and second tray 4′ do not bump into each other preventing system 2 from working or from moving apart from each other. As such, in operation first tray 4 hits its respective bumper on the down swing, and then an instant later second tray 4′ hits its bumper, avoiding the operation of the two from interfering with each other. First tray 4 and at least second tray 4′ may be coupled via welding, a hook mechanism 29, or other connection. Each additional tray to system is supported by two or more vertical supports and includes a bumper.

FIG. 9 illustrates an embodiment including a cam 20 and follower 22 mechanism. As illustrated, tray 4 is coupled to follower 22 such that tray 4 moves with follower 22. Follower maintains contact with cam 20. Cam 20 is off center and snail shaped. Cam 20 is coupled to second pulley wheel 24′. Single speed motor 14 is coupled to first pulley wheel 24. Belt 26 rotates around first and second pulley wheel 24, 24′ such that movement from motor 14 is transferred via belt 26 and pulley wheels 24, 24′ to cam 20. As cam 20 rotates, follower 22 reciprocates motion according to shape of cam 20. Shape of cam 20 produces movement that generally results in tray 4 and follower 22 moving in backward direction 32 during first portion 34 of a rotational cycle, and moving in a freefall, forward direction 40 during second portion 38 of a rotational cycle.

Referring to FIG. 10, illustrates an embodiment of drive arm 28 as a self-compensating connecting rod 1000. Self-compensating connecting rod 1000 includes a solid longitudinal portion 1004 with a crank bearing 1002 positioned on a first end of longitudinal portion 1004. Crank bearing 1002 is configured to attach to a crank journal 19 and such that self-compensating connecting rod 1000 may move together with pulley wheels 24, 24′ and belt 26 when attached to crank journal 19 (see other FIGS.). Longitudinal portion 1004 is connected to a cylinder 1006 at a second end, opposite the first end and crank bearing 1002. A piston 1008 is partially disposed in cylinder 1006 such that piston 1008 may slide forward and backward in cylinder 1006. It is contemplated that element 1006 need not be cylindrical, but may be other shapes such as circular, rectangular, square. Piston 1008 moves in cylinder 1006 such that additional stress is not put on crank journal 19 and longitudinal portion 1004 as drive arm 28 moves with pully wheels 24, 24′. A spring 1010, or a pair of springs 1010, 1010′ are at least partially disposed in cylinder 1006 at an end opposite the longitudinal portion 1004. Springs 1010, 1010′ are positioned to interact with piston 1008 as piston 1008 slides forward and backward in cylinder 1006. Springs 1010, 1010′ reduce shock loading as the piston 1008 slides in the cylinder 1006 due to the momentum of the movement from the longitudinal portion 1004 and the crank bearing 1002. A stop tube 1012 is positioned axially internal or external to springs 1010, 1010′ (shown externally positioned) to prevent over compression of springs 1010, 1010′. In one example spring 1010 may be a single spring, or may be a pair or springs 1010, 1010′ (such as a clamshell of “springy” materials that may closed on the outside of piston 1008. Similarly, stop tube 1012 may be a single piece fitted about springs 1010, 1010′ or may be multiple clam-shelled components 1012/1012′, as well. Piston 1008 includes a connection point or interface 1017 between the piston rod 1014 extending from an end of piston 1008 and extending at least a portion out of cylinder 1006. Piston rod 1014 is connected to a bracket 1019 by at least a flexible element 1016. Bracket 1019 connects self-compensating connecting rod 1000 to the tray 4 such that movement of self-compensating connecting rod 1000 enables tray 4 to move as discussed above in detail. Flexible element 1016 connects piston rod 1014 to bracket 1019 to allow pivoting to occur between bracket 1019 and piston rod 1014 such that lubrication between parts is not required to reduce required maintenance and mechanical wear of parts, in this and other disclosed embodiments herein.

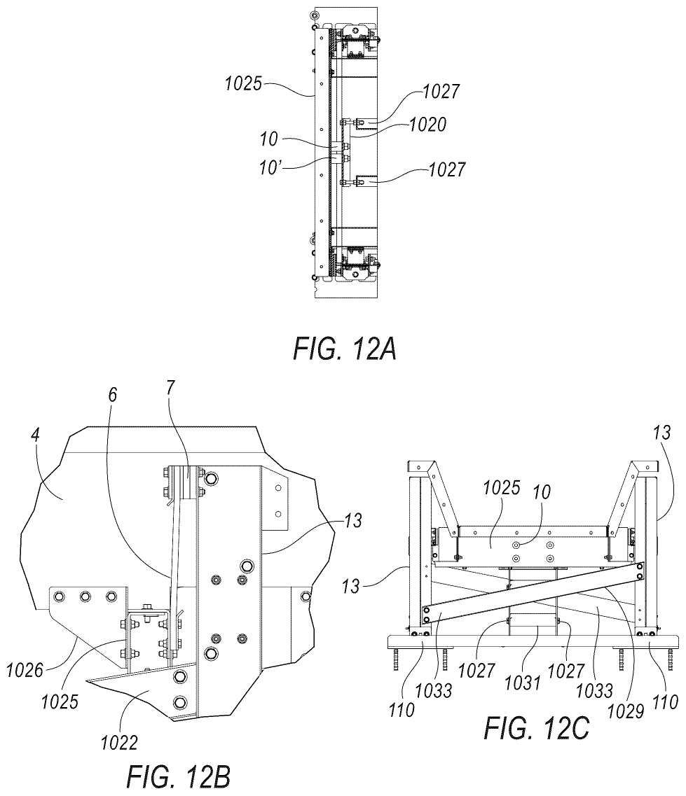

Referring to FIGS. 11A, 11B, 12A, 12B, and 12C system 2 is shown with more than one tray 4, 4′. FIG. 11A shows the overall system with multiple trays 4, 4′ and FIG. 11B shows a close up view of two of the trays 4, 4′ from FIG. 11A. FIG. 12A shows a top view of a bumper impact cross beam 1025 and associated assembly components also related to FIGS. 11A and 11B. FIG. 12B shows a side view of bumper impact cross beam 1025 and associated assembly components also related to FIGS. 11A and 11B. FIG. 12C shows a front view of bumper impact cross beam 1025 and associated assembly components also related to FIGS. 11A and 11B.

Referring to these figures, elements that are common to the figures above are indicated has having the same reference numerals where appropriate. However, in the illustrations related to FIGS. 11A, 11B, 12A, 12B, and 12C, rotating input mechanism 8 incudes a drive arm 28 that is attached to a connecting rod interface bracket 1024, which is directly connected bumper impact cross beam 1025, which is then connected to its tray support 1026 in the left most tray 4. Tray supports 1026 generally are attached to tray 4 to either lateral side thereof, which from tray to tray are connected directly to either a bumper impact cross beam 1025 or a non-bumper impact cross beam 1029. The illustrated assembly also includes two support structures 1027 (visible in side views of FIGS. 11A and 11B) and also in the top view of FIG. 12A, which extend axially along the assembly. For those trays where support structures 1027 are provided between support bars 13, bumpers 10 are also included such as is visible in FIGS. 12A and 12C, which are supported by a stationary bumper mount 1020 that spans support structures 1027. However, in some axial locations no support structures 1027 are included. In these instances no bumpers 10 are provided and as such non-bumper impact cross beams 1029 are provided which are positioned similarly as bumper impact cross beams 1025 in other locations, but since no bumpers 10 are provided there is no bumping occurring during system operation. Axial support bars 1022 provide structural support axially.

Thus, on the input end of things, tray supports 1026 are connected via bumper impact cross beam 1025. In this fashion, connecting rod interface bracket 1024 is positioned on center laterally, and is connected to bumper impact cross beam 1025 that extends the width of trays 4/4′, which are thereby connected to tray supports 1026, thereby transferring mechanical input from rotating input mechanism 8 to either side of trays 4/4′. In subsequent axial locations of the various trays 4/4′, bumpers 10 may or may not be included, depending on system requirements, and if not included at a certain location then non-bumper impact cross beams 1029 may be used in lieu of bumper impact cross beams 1025.

The illustrated assembly includes two support structures 1027 (visible in side views of FIGS. 11A and 11B) and also in the top view of FIG. 12A, which extend axially along the assembly, and which are joined by a cross-support 1031. Support structures 1027 provide structural support axially between support bars 13, and also provide support for stationary bumper mount 1020, while cross beam support structures 1033 provide lateral cross beam support between support structure 1027 as seen in FIG. 12C.

Thus, in operation, and based on mechanical input from drive arm 28, axial motion is input to the arrangement of trays 4/4′ via bumper impact cross beam 1025 on the left-most tray 4 via connecting rod interface bracket 1024. Upon release from the trays 4/4′ at their top most portion of the swinging operation, trays 4/4′ swing forward and bumper cross beams 1025 are caused to impact bumpers 10 that are stationary and positioned on stationary bumper mount 1020.

Thus, as trays 4/4′ connect or impact with bumper 10 and are prevented from moving forward further, forward momentum of conveyed material 12 continues such that the static friction of conveyed materials 12 is overcome and materials 12 subsequently advance in forward direction 40. One directional continuously rotating mechanism 8 is configured such that as tray 4 hits bumper 10, excessive wear on input mechanism 8 is reduced or eliminated as input mechanism 8 is subsequently only moving tray 4 in backward direction 32. Input mechanism 8 thus does not deteriorate due to excessive wear and shock loading, allowing system 2 to be utilized without the need for maintenance and repairs that exist in other systems.

According to one aspect, a conveyor system includes a tray suspended from above by two or more vertical supports, such that the tray travels in a forward direction from a tray high point to a tray low point. The system includes a one directional continuously rotating input mechanism that during a first portion of a single rotational cycle moves the tray in a backward direction, opposite the forward direction, to the tray high point, and during a second rotational cycle allows unrestrained freefall of the tray in the forward direction. The system includes a bumper positioned to provide a sudden stop to the tray as the tray travels in the forward direction, such that the tray bounces and travels in the backward direction, and such that a conveyed material positioned on the tray continues in the forward direction due to a forward momentum of the conveyed material.

According to another aspect, a method of conveying materials includes moving a tray in a backward direction during a first portion of a rotational cycle, such that the tray is configured to be moved by a one-directional continuously rotating input mechanism, releasing the tray in unrestrained freefall in a forward direction during a second portion of a rotational cycle, providing a sudden stop to the tray at a bumper as the tray travels in the forward direction, and bouncing the tray in a backward direction, such that conveyed material on the tray continues in a forward direction due to a forward momentum of the conveyed material.

When introducing elements of various embodiments of the disclosed materials, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

While the preceding discussion is generally provided in the context of a pendulum conveyor system, it should be appreciated that the present techniques are not limited to such limited contexts. The provision of examples and explanations in such a context is to facilitate explanation by providing instances of implementations and applications. The disclosed approaches may also be utilized in other contexts or configurations.

While the disclosed materials have been described in detail in connection with only a limited number of embodiments, it should be readily understood that the embodiments are not limited to such disclosed embodiments. Rather, that disclosed can be modified to incorporate any number of variations, alterations, substitutions or equivalent arrangements not heretofore described, but which are commensurate with the spirit and scope of the disclosed materials. Additionally, while various embodiments have been described, it is to be understood that disclosed aspects may include only some of the described embodiments. Accordingly, that disclosed is not to be seen as limited by the foregoing description, but is only limited by the scope of the appended claims.

What is claimed is:

1. A conveyor system, comprising:
a tray suspended by two or more vertical supports, such that the tray travels in a forward direction from a tray high point toward or through a tray low point;
a one directional continuously rotating input mechanism that:
during a first portion of a single rotational cycle moves the tray in a backward direction, opposite the forward direction, to the high point; and
during a second portion of a single rotational cycle allows unrestrained freefall of the tray in the forward direction; and
a bumper positioned to provide a sudden stop to the tray as the tray travels in the forward direction, such that the tray bounces and travels in the backward direction, and such that a conveyed material positioned on the tray continues in the forward direction due to a forward momentum of the conveyed material.

2. The system of claim 1, wherein the vertical supports are positioned in a V shape with respect to one another.

3. The system of claim 1, wherein the two or more vertical supports are straps.

4. The system of claim 1, further comprising a stationary upper location from which the vertical supports are suspended.

5. The system of claim 1, wherein the one directional continuously rotating input mechanism includes a continuously rotating single speed motor and a one directional bearing.

6. The system of claim 5, wherein the one directional bearing is a sprag bearing.

7. The system of claim 5, wherein the one directional bearing is a cam and a follower.

8. The system of claim 5, wherein the one direction bearing is integral to the continuously rotating single speed motor.

9. The system of claim 5, further comprising a first pulley wheel, a second pulley wheel and a belt, with the one directional bearing coupled to the second pulley wheel via the first pulley wheel and the belt.

10. The system of claim 9, further comprising a drive arm connected to the tray, the one directional continuously rotating input mechanism coupled to the tray by the drive arm.

11. The system of claim 1, wherein the bumper is positioned past the tray low point such that the tray is configured to travel through the tray low point.

12. The system of claim 5, wherein a drive arm is coupled from the tray to the one directional continuously rotating input mechanism, such that the drive arm and the tray move with each other when the one directional continuously rotating input mechanism is engaged.

13. The system of claim 1, wherein the tray includes side walls extending vertically from a base of the tray.

14. The system of claim 1, further comprising a second tray supported by the two or more vertical supports.

15. The system of claim 14, wherein the second tray is hard coupled to the first tray.

16. The system of claim 14, wherein the second tray is loosely coupled to the first tray such that the second tray is moved by the first tray, the second tray travels to a tray low point less far than the first tray, and the second tray hits the bumper before the first tray.

17. A method of conveying materials, comprising:
moving a tray in a backward direction during a first portion of a rotational cycle, the tray configured to be moved by a one-directional continuously rotating input mechanism;
releasing the tray in unrestrained freefall in a forward direction during a second portion of a rotational cycle;
providing a sudden stop to the tray at a bumper as the tray travels in the forward direction; and
bouncing the tray in a backward direction, such that conveyed material on the tray continues in the forward direction due to a forward momentum of the conveyed material.

18. The method of claim 17, further comprising hanging the tray from two or more vertical supports.

19. The method of claim 18, further comprising swinging the tray from the two or more vertical supports.

20. The method of claim 17, further comprising coupling a drive arm from the tray to the one-directional continuously rotating input mechanism.
